(19) United States
(12) Patent Application Publication
(10) Pub. No.: US 2022/0183907 A1
(43) Pub. Date: Jun. 16, 2022

(54) BED PLATFORM ASSEMBLY COMPRISING A PLURALITY OF DIFFERENT, INDIVIDUALLY AND INDEPENDENTLY CONTROLLED PIVOTALLY OR LINEARLY MOVABLE SECTIONS FOR AUTOMATICALLY MOVING A PERSON FROM A SUPINE POSITION TO SITTING AND STANDING POSITIONS, AS WELL AS FOR AUTOMATICALLY MOVING THE PERSON IN A REVERSE MODE FROM STANDING AND SITTING POSITIONS TO A SUPINE POSITION

(71) Applicant: HHC Changzhou Corporation, Changzhou (CN)

(72) Inventors: Chih Hsiung Liu, Benoni (ZA); Mei Jun Xu, Jiujiang (CN); Hai Guo Jiang, Changzhou (CN)

(21) Appl. No.: 17/117,247

(22) Filed: Dec. 10, 2020

(51) Int. Cl. A61G 7/015; A61G 7/053

(52) U.S. Cl. CPC A61G 7/015; A61G 7/018; A61G 7/053

(57) ABSTRACT

A bed platform assembly, which may be used, for example, within hospitals, nursing homes, senior care or specialized care facilities, or the like, comprises a plurality of different, individually controlled pivotally or otherwise movable sections so as to automatically assist a person to be moved from a supine position to sitting and standing positions such that the person can be assisted by hospital, nursing home, or other facility staff or personnel to participate in, for example, ambulatory or physical therapy sessions as may be needed or required such that the person can heal or recover from an accident, surgery, or the like. Conversely, the bed platform assembly can be operated in a reverse mode so as to automatically assist the person to be moved from standing and sitting positions back to the supine position.

### FIELD OF THE INVENTION

The present invention relates generally to beds, and more particularly to a bed platform assembly which may be used, for example, within hospitals, nursing homes, senior care or specialized care facilities, or the like, and which comprises a plurality of different, individually controlled pivotally or otherwise movable sections so as to automatically assist a person to be moved from a supine position to sitting and standing positions such that the person can be assisted by hospital, nursing home, or other facility staff or personnel to participate in, for example, ambulatory or physical therapy sessions as may be needed or required such that the person can heal or recover from an accident, surgery, or the like, as well as to be moved in a reverse mode so as to automatically assist the person to be moved from standing and sitting positions back to the supine position.

### BACKGROUND OF THE INVENTION

Unfortunately, many people find themselves in a hospital, nursing home, senior care facility, a specialized care facility, or the like, for any one of various different reasons. For example, they may have been involved in an accident, or they may have been attacked, or they may have undergone a necessary surgical procedure, or they may be afflicted with a particular disease, or they may simply be elderly and require constant supervision within a senior care facility or a nursing home. Whatever the reason, the person needs to be periodically moved, probably multiple times per day, from his or her bed in order to permit the body to undergo its natural ambulatory movements, or in order to perform specific physical therapy exercises in order to help specific body parts to become stronger, or to simply prevent the person from developing further complications, such as, for example, bed sores, which may develop as a result of the person lying in a supine position for extended periods of time. One significant problem, however, in achieving these movements or exercises, is that it may be somewhat difficult for hospital or similar facility staff or personnel to actually be capable of moving the person from the supine position to the seated and standing positions such that the person can then be ready to participate in the desired ambulatory movements or physical therapy exercises.

A need therefore exists in the art for a new and improved bed platform assembly. An additional need exists in the art for a new and improved bed platform assembly which can address the aforenoted problems or difficulties that bed-ridden people face. A further need exists in the art for a new and improved bed platform assembly which can address the aforenoted problems or difficulties that bed-ridden people face, whereby the bed platform assembly can effectively automatically move the person from a supine position to seated and standing positions without any assistance or help from hospital or facility staff or personnel. A still further need exists in the art for a new and improved bed platform assembly which can address the aforenoted problems or difficulties that bed-ridden people face, whereby the bed platform assembly can effectively automatically move the person from a supine position to seated and standing positions such that hospital or similar facility staff or personnel are relieved from the difficulties of actually moving the person from the supine position to the seated and standing positions. A yet further need exists in the art for a new and improved bed platform assembly which can address the aforenoted problems or difficulties that bed-ridden people face, whereby the bed platform assembly can effectively automatically assist and move the person from a supine position to seated and standing positions such that hospital or similar facility personnel are relieved from the difficulties of actually moving the person from the supine position to the seated and standing positions but can then assist or help the person to ambulate and/or participate in physical therapy exercises. A last need exists in the art for a new and improved bed platform assembly which can address the aforenoted problems or difficulties that bed-ridden people face, whereby the bed platform can effectively operate in a reverse mode so as to automatically move the person from standing and seated positions back to the supine position after the person has completed his or her ambulatory or physical therapy movements or exercises.

### OVERALL OBJECTIVES OF THE PRESENT INVENTION

An overall objective of the present invention is to provide a new and improved bed platform assembly. An additional overall objective of the present invention is to provide a new and improved bed platform assembly which can address the aforenoted problems or difficulties that bed-ridden people face. A further overall objective of the present invention is to provide a new and improved bed platform assembly which can address the aforenoted problems or difficulties that bed-ridden people face, whereby the bed platform assembly can effectively automatically move the person from a supine position to seated and standing positions without any assistance or help from hospital or facility staff or personnel. A still further overall objective of the present invention is to provide a new and improved bed platform assembly which can address the aforenoted problems or difficulties that bed-ridden people face, whereby the bed platform assembly can effectively automatically move the person from a supine position to seated and standing positions such that hospital or similar facility staff or personnel are relieved from the difficulties of actually moving the person from the supine position to the seated and standing positions. A yet further overall objective of the present invention is to provide a new and improved bed platform assembly which can address the aforenoted problems or difficulties that bed-ridden people face, whereby the bed platform assembly can effectively automatically move the person from a supine position to seated and standing positions such that hospital or similar facility personnel are relieved from the difficulties of actually moving the person from the supine position to the seated and standing positions but can then assist or help the person to ambulate and/or participate in physical therapy exercises. A last overall objective of the present invention is to provide a new and improved bed platform assembly which can address the aforenoted problems or difficulties that bed-ridden people face, whereby the bed platform assembly can effectively operate in a reverse mode so as to automatically move the person from standing and seated positions back to the supine position after the person has completed his or her ambulatory or physical therapy movements or exercises.

### SUMMARY OF THE INVENTION

The foregoing and other objectives are achieved in accordance with a new and improved bed platform assembly, developed in accordance with the principles and teachings of the present invention, wherein the bed platform assembly defines a flat, horizontally oriented bed platform assembly which comprises a plurality of different, individually and/or independently controlled, pivotally and/or otherwise movable sections which are mounted upon an underlying bed frame. More particularly, the bed platform assembly comprises a neck section or deck, a back section or deck, a seat section or deck, a thigh section or deck, a leg section or deck, and a foot section or deck, all of the top or upper surface portions of which are normally disposed within a single horizontal plane so as to properly support the person disposed in the supine position. All of the sections or decks comprising the bed platform assembly are operatively connected together in an articulated manner for pivotal movement, with the exception of the foot section or deck which is separate from the other bed sections or decks and which is adapted to be moved in a linear manner in upward or downward directions as operatively required during different phases of operation of the various other sections or decks of the new and improved bed platform assembly. More particularly, it is to be noted that the neck section or deck is pivotally attached to one end of the back deck or section in an articulated manner, while the opposite end of the back deck or section is pivotally attached to one side or end of the seat section or deck in an articulated manner. In a similar manner, one end of the thigh section or deck is pivotally attached to the opposite side or end of the seat section or deck in an articulated manner, while the leg section or deck is pivotally attached to the opposite end of the thigh section or deck in an articulated manner.

Still further, the seat section or deck is mounted atop a rotational or pivotal framework such that the seat section or deck can undergo rotational or pivotal movement, and the pivotal framework is, in turn, mounted upon an underlying tilting chassis. The tilting chassis, in turn, is connected to the underlying bed frame through means of a suitable actuator which has one end thereof connected to a first horizontally oriented rod member forming one side or end of the tilting chassis while the opposite end thereof is operatively connected to the underlying bed frame. A second horizontally oriented rod member forming the opposite side or end of the tilting chassis is fixedly connected to the underlying bed frame such that the second horizontally oriented rod member of the tilting chassis effectively defines a horizontally oriented rotational axis about which the tilting chassis will be pivotally moved between elevated and lowered positions. Therefore, when the actuator is extended, the tilting chassis, along with the rotary framework and the seat section or deck, is moved to a tilted position having an angular displacement of approximately 23° after the rotational or pivotal framework and the seat section or deck have been rotated through 90° from their original positions, whereas when the actuator is retracted, the tilting chassis, along with the rotary framework and the seat section or deck, are returned to their normal horizontally oriented positions. Each one of the movable components of the new and improved bed platform of the present invention is provided with a separate, independently controlled, linear actuator which, in turn, is controlled by means of a suitable central processing unit (CPU) or programmable logic controller (PLC).

In operation, when it is desired to move a person, lying upon the bed platform assembly, from a supine position to a seated and standing position, the linear actuator for the back deck or section is activated first so as to slowly move the back deck or section from its normally flat, horizontally oriented position, to an upward or elevated position of approximately 45° degrees such that the person's back is properly supported in an inclined position. It is noted that the linear actuator for the neck deck or section can also be activated at this time, if desired, so as to likewise position and support the person's neck at a suitably comfortable angle with respect to the back deck or section. The thigh, leg, and foot linear actuators are then activated so as to respectively elevate the thigh, leg, and foot sections or decks to predetermined elevated positions, as well as to support the thighs, legs, and feet of the person at such elevated positions in preparation for the person to ultimately be moved to the ultimately desirable seated and standing positions. The linear actuator for the foot deck or section is then operated in reverse so as to lower the foot deck or section such that the foot deck or section is now at an elevation which is substantially below that at which the person's thighs and legs are disposed. Subsequently, the linear actuator for the rotational or pivotal framework is then activated such that the seat deck or section, fixedly mounted upon the rotational or pivotal framework, is rotated or moved through an arcuate extent of 90° along with the neck and back sections or decks, which are connected to one end or side of the seat deck or section, as well as the thigh section or deck, and the leg section or deck, which are connected to the opposite end or side of the seat deck or section. In this manner, it can be appreciated that the person is now effectively positioned perpendicular to the longitudinal extent of the underlying bed frame and that the person's legs now extend over a side edge portion of the underlying bed frame and are disposed at a predetermined height or elevation above the floor upon which the underlying bed frame is disposed. It can be appreciated further that since the foot section or deck was lowered back to its normal or retracted position, the foot section or deck will not interfere with, or encounter, the person's legs or the leg section or deck when the rotary framework, along with the seat section or deck, is rotated through the aforenoted 90° rotational movement. Alternatively, the foot deck or section may be stationary so as to merely support the person's feet when the person is disposed upon the bed platform in the supine position but will nevertheless be disposed beneath the elevational level at which the person's thighs and legs will be disposed when the linear actuators for the person's thighs and legs are activated so as to elevate the person's thighs and legs to their predetermined elevated positions.

Continuing further, once the person has attained the aforenoted 90° rotational position with respect to the underlying bed frame such that the person's legs now extend over a side edge portion of the underlying bed frame and are disposed at a predetermined height or elevation above the floor upon which the underlying bed frame is disposed, the linear actuator for the tilting chassis will be activated to be predetermined degrees, such as, for example, 23° with respect to its normal horizontal position. Subsequently, the linear actuators for the person's thighs and legs are retracted such that the thigh and leg sections or decks are moved downwardly such that the person's feet are now able to touch the floor, at which time the person may be assisted by hospital or other facility personnel or staff so as to attain a fully standing position, or alternatively, the person may be able to attain a fully standing position by himself/herself by using, for example, a walker or other device for enabling the person to ambulate as desired. It is to be lastly appreciated that the mode of operation of the bed platform assembly can effectively be operated in reverse whereby a person, having navigated, or having been assisted, toward the side of the bed frame, either alone or with assistance from hospital or other facility staff or personnel, can be seated, and subsequently, the various linear actuators can be activated in their respective reverse modes of operation so as to effectively return the person to the supine position after the person has completed his or her ambulatory or physical therapy movements or exercises.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic top plan view of the new and improved bed platform assembly comprising a plurality of different, individually and independently controlled pivotally or otherwise movable sections or decks so as to be automatically operated in a first mode so as to assist a person to be moved from a supine position to sitting and standing positions, as well as to be automatically operated in a second reverse mode so as to assist the person to be moved from standing and sitting positions back to the supine position;

FIG. 2 is a schematic side elevational view of the new and improved bed platform assembly as illustrated within FIG. 1, illustrating the various, different sections or decks of the bed platform assembly which define a horizontally oriented bed platform assembly mounted upon an underlying bed frame and upon which a person may be disposed in a supine position;

FIG. 3 is a schematic front, top perspective view of the new and improved bed platform assembly as illustrated within FIGS. 1 and 2 and illustrating the movement of the various different bed platform sections or decks to various operative positions relative to the underlying bed frame;

FIG. 4 is a schematic view disclosing the mounting of the neck deck linear actuator for moving the neck section or deck of the new and improved bed platform assembly relative to the back section or deck of the new and improved bed platform assembly;

FIG. 5 is a schematic view disclosing the mounting of the back deck linear actuator for moving the back section or deck of the new and improved bed platform assembly relative to the seat section or deck;

FIG. 6 is a schematic view disclosing the mounting of the thigh deck linear actuator for moving the thigh section or deck of the new and improved bed platform assembly relative to the seat section or deck;

FIG. 7 is a schematic view disclosing the mounting of the leg deck linear actuator for moving the leg section or deck of the new and improved bed platform assembly relative to the thigh section or deck;

FIG. 8 is a schematic view disclosing the mounting of the foot deck linear actuator for moving the foot section or deck of the new and improved bed platform assembly relative to the underlying bed frame;

FIG. 9 is a schematic view disclosing the mounting of the rotational platform assembly upon the tilting chassis which is pivotally mounted upon the underlying bed frame;

FIG. 10 is a schematic view disclosing the mounting of the tilting chassis linear actuator having one end connected to an underlying chassis while the other end is connected to the tilting chassis for tilting the tilting chassis relative to the underlying bed frame when desired;

FIG. 11 is a schematic top plan perspective view similar to that of FIG. 9 but illustrating in better detail precisely how the rotational platform assembly is mounted upon the tilting chassis, and how the tilting chassis is mounted upon the underlying bed frame;

FIG. 12 is a schematic top perspective view similar to that of FIG. 11 but illustrating in better detail the first and second oppositely disposed horizontally oriented rod members of the tilting chassis, as well as a rotational frame which is mounted atop the rotational platform assembly and upon which the seat section or deck is fixedly mounted such that the seat section or deck can rotate along with the rotational frame and rotational platform assembly when a rotational actuator, operatively connected to the rotational platform assembly, is actuated;

FIG. 13 is a schematic vertical cross-sectional view of the rotational platform assembly illustrating the rotational/pivotal frame, and the rotational platform assembly, as mounted upon the tilting chassis wherein, in particular, it is seen that the rotational platform assembly comprises a lower section fixedly secured to the tilting chassis and an upper section rotatably movable with respect to the fixed lower section through means of a surface bearing and rotatable with a vertically oriented axial shaft or spindle which is =rotatable relative to the tilting chassis by means of a plurality of annular bearing members, and wherein an annular rotary gear is fixedly mounted upon the vertically oriented axial shaft or spindle and is adapted to be operatively engaged by means of a linearly movable rack which is operatively disposed upon the end of a telescopic tube of a rotational or pivotal linear actuator;

FIG. 14 is a schematic vertical cross-sectional view similar to that of FIG. 13 but taken from a perspective which is 90° moved from the perspective of FIG. 13; and

FIG. 15 is a schematic illustration of a control box upon which are mounted a plurality of control buttons which control the various actuators operatively connected to the various different sections or deck members, as well as the rotational and tilting actuators, a motion sensor, and LED lighting located beneath the bed frame supporting the bed platform assembly.

### DETAILED DESCRIPTION OF THE PREFERRED EMBODIMENT

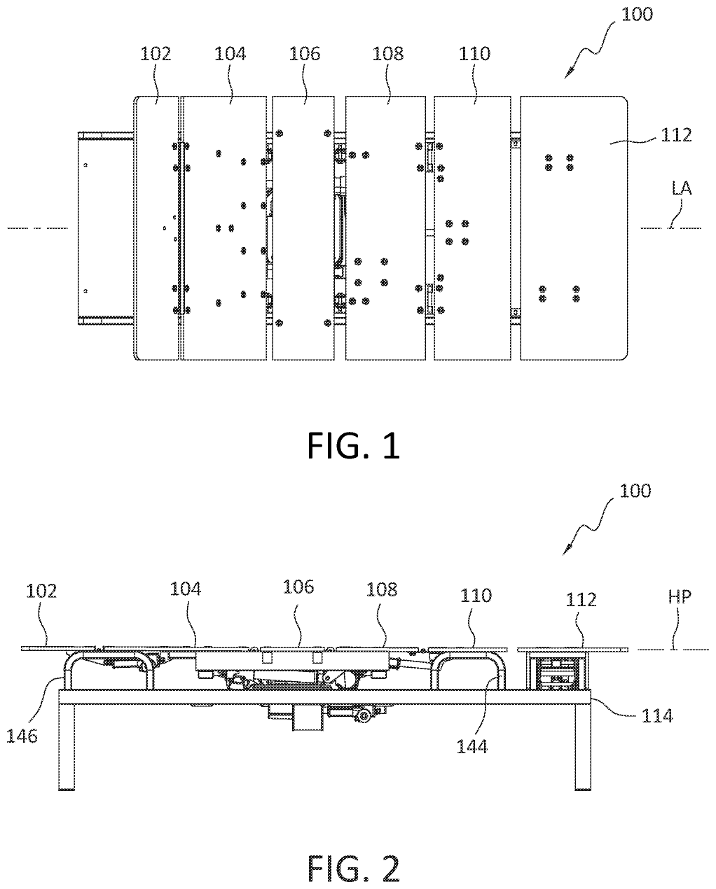

Referring now to FIGS. 1-3, the new and improved bed platform assembly, developed in accordance with the principles and teachings of the present invention, is disclosed and is generally indicated by means of the reference character 100. More particularly, as can be appreciated from FIGS. 1 and 2, the bed platform assembly 100 normally defines a flat, horizontally oriented platform which comprises a plurality of different, individually and independently controlled, articulated and/or otherwise movable sections 102-112 which are mounted upon an underlying bed frame 114 having a longitudinal axis LA. More specifically, the bed platform assembly 100 is seen to comprise a neck section or deck 102, a back section or deck 104, a seat section or deck 106, a thigh or upper leg section or deck 108, a lower leg section or deck 110, and a foot section or deck 112, all of the upper surface portions of which are disposed within a single horizontal plane HP so as to properly support the person disposed in the supine position upon the bed platform assembly 100. All of the sections or decks 102-112 comprising the bed platform assembly 100 are operatively connected together and are mounted for articulated or pivotal movement, with the exception of the foot section or deck 112 which is separate from the other bed sections or decks 102-110 and which is adapted to be moved only in a linear manner in upward or downward directions as required during different phases of operation of the new and improved bed platform. In addition, the seat section or deck 106 is mounted atop a rotational platform which, in turn, is mounted upon an underlying tilting chassis, all of which will also be disclosed and explained more fully hereinafter, and therefore, the rotational platform only undergoes a rotational or arcuate movement through an angular extent of, for example, 90°, with the back deck or section 104 and the thigh deck or section 108 connected in an articulated manner to opposite ends or sides of the seat section or deck 106. The tilting chassis, in turn, is connected to the underlying bed frame 114 through means of a suitable actuator which has one end thereof connected to the tilting chassis while the opposite end thereof is operatively connected to the underlying bed frame 114, all of which also be more fully disclosed and explained hereinafter. When the actuator is extended, the tilting chassis, along with the rotational platform and the seat section or deck 106, is moved to a tilted position having an angular displacement of approximately 23° after the rotational platform and the seat section or deck 106 have rotated through 90° from their original positions, whereas when the actuator is retracted, the tilting chassis, along with the rotational platform and the seat section or deck 106, are returned to their normal horizontally oriented positions. Each one of the movable components of the new and improved bed platform assembly 100 of the present invention is provided with a separate, independently controlled, linear actuator which, in turn, is controlled by means of a programmable logic controller (PLC) or a central processing unit (CPU), all of which will be disclosed more fully hereinafter and with reference being made to additional drawings.

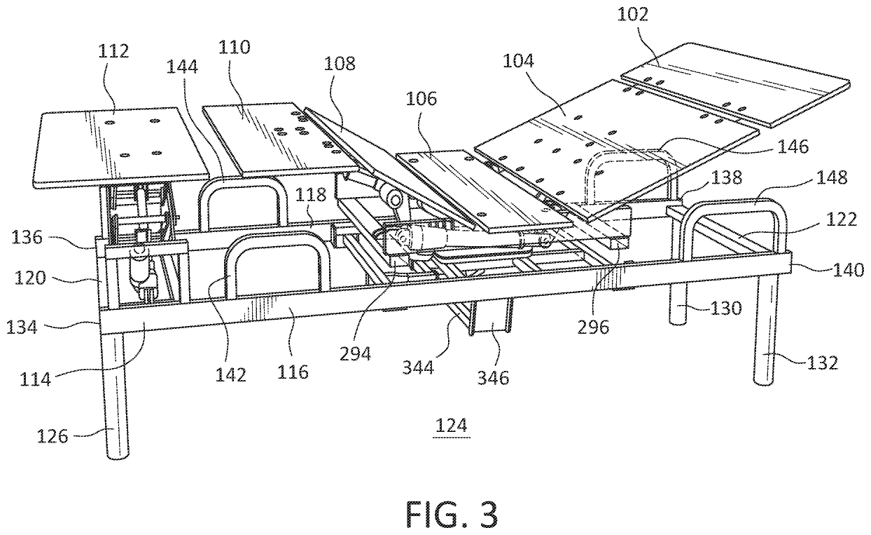

With reference again being made to FIG. 3, the various decks or sections 102-112 are disclosed as they may be initially moved to various raised or elevated or inclined positions relative to the underlying bed frame 114 when such sections or decks 102-112 are being readied to move a person from the supine position to the seated and tilted position so as to enable the person to be capable of subsequently ambulating for ambulatory or physical therapy exercise. It is seen from FIG. 3 that the underlying bed frame 114 has a substantially rectangular configuration as defined by means of two longitudinally extending, oppositely disposed side frame members 116,118, as well as two laterally or transversely extending, oppositely disposed end frame members 120,122. In addition, the underlying bed frame 114 is supported at an elevated position above a floor 124 by means of four legs 126,128,130,132 which are respectively attached to undersurface portions of the two longitudinally extending, oppositely disposed side frame members 116,118 so as to be disposed within four corner regions 134,136,138,140 of the underlying bed frame 114, it being noted that leg 128 is not visible in FIG. 3. Still further, it is also seen that the underlying bed frame 114 is also provided with four upstanding support brackets 142,144,146,148, each one of which has a substantially inverted U-shaped configuration and are attached to upper surface portions of the two longitudinally extending, oppositely disposed side frame members 116,118 so as to effectively be disposed at opposite ends of the underlying bed frame 116, and at or near the four corner regions 134,136,138,140 of the underlying bed frame 116 so as to provide support for the leg section or deck 110 and the back section or deck 104 when all of the sections or decks 102-112 are disposed at their lowered positions as illustrated within FIG. 2.

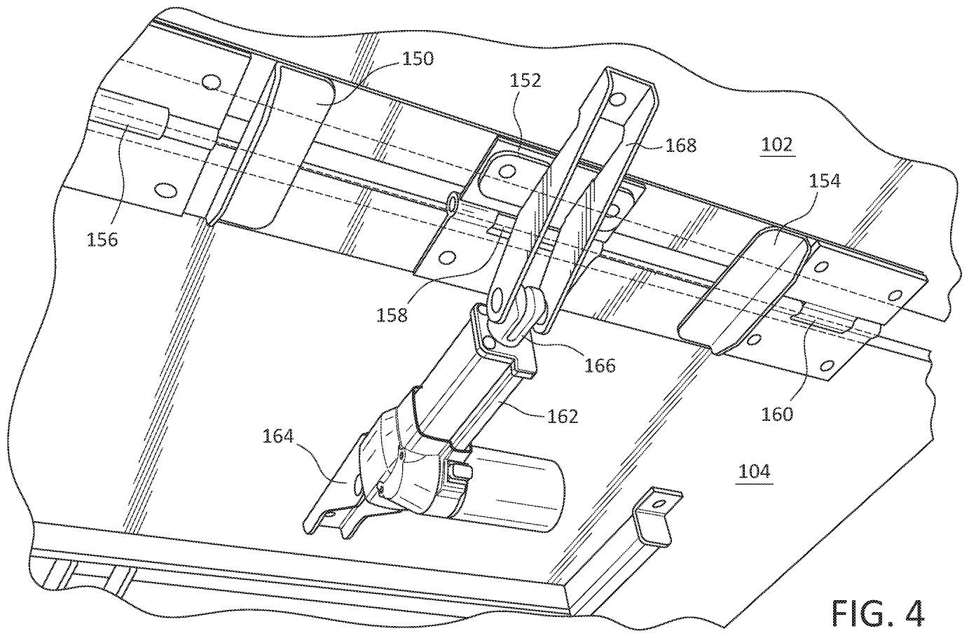

Having explained the overall general structure of the new and improved bed platform assembly 100, as constructed in accordance with the principles and teachings of the present invention, a detailed explanation of each section will now be described. Accordingly, with reference being made to FIG. 4, the neck section or deck 102 is shown attached to the back section or deck 104. More particularly, it is seen that the neck section or deck 102 is pivotally attached to the back section or deck 104 by means of a plurality of mounting brackets 150,152,154 wherein each one of the mounting brackets 150,152,154 comprises two bracket sections connected together by means of a suitable hinge structure 156,158,160 such as, for example, a piano hinge mechanism. In addition, a neck deck actuator 162 is fixedly connected to a laterally central undersurface portion of the back section or deck 104 by means of a suitable mounting bracket or motor mount 164, and it is seen that the neck deck actuator 162 has an extendable telescopic tube 166 which is adapted to be pivotally connected to one end of a clevis connector 168 while the opposite end of the clevis connector 168 is fixedly secured to a laterally central undersurface portion of the neck section or deck 102. In this manner, as the telescopic tube 166 is extended out from the neck deck actuator 162, the neck section or deck 102 will be pivotally moved with respect to the back section or deck 104 as may be desired for the proper support and comfort of the neck of the person being moved from the supine position to the seated and partially standing position.

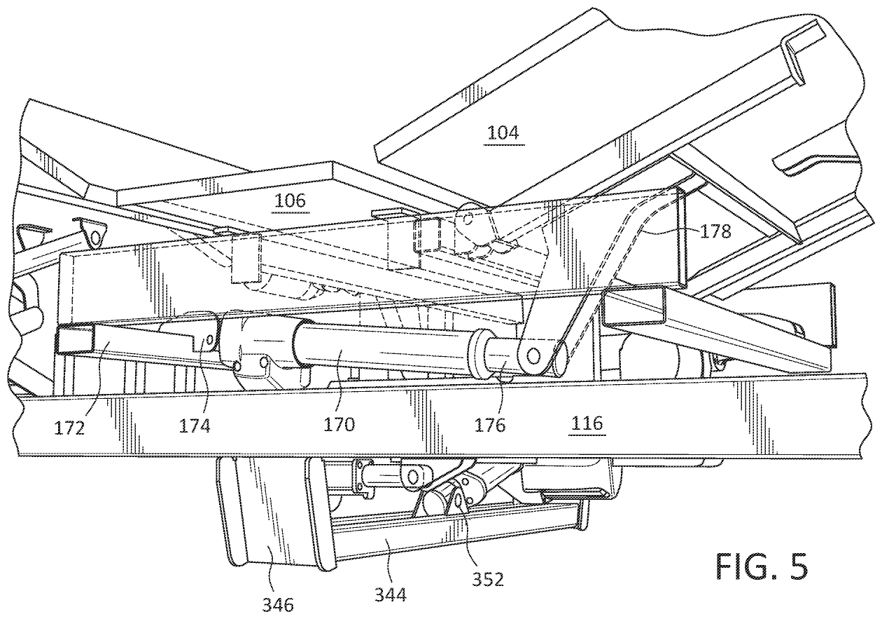

Continuing further, and with reference now being made to FIG. 5, the mounting of the back section or deck 104 upon one side or end of the seat section or deck 106, and the movement of the back section or deck 104 with respect to the seat section or deck 106, will now be described. More particularly, it is seen that the back section or deck 104 is pivotally attached to one side or one end of the seat section or deck 106 by means of a plurality of mounting brackets, not shown but similar to the mounting brackets 150,152,154, wherein each one of the mounting brackets comprises two bracket sections connected together by means of a suitable hinge structure such as, for example, a piano hinge mechanism. In addition, a back deck actuator 170 is fixedly connected to a transversely oriented beam member 172 of the bed frame 114 by means of a motor mount 174, and the back deck actuator 170 comprises an extendable telescopic tube 176. In turn, the extendable telescopic tube 176 is pivotally connected to one end of a clevis connector 178 while the other end of the clevis connector 178 is fixedly connected to a laterally central undersurface portion of the back section or deck 104. In this manner, as the telescopic tube 176 is extended out from the back deck actuator 170, the back section or deck 104 will be pivotally moved with respect to the seat section or deck 106 as may be desired for the proper support and comfort of the back portion of the person being moved from the supine position to the seated and partially standing position.

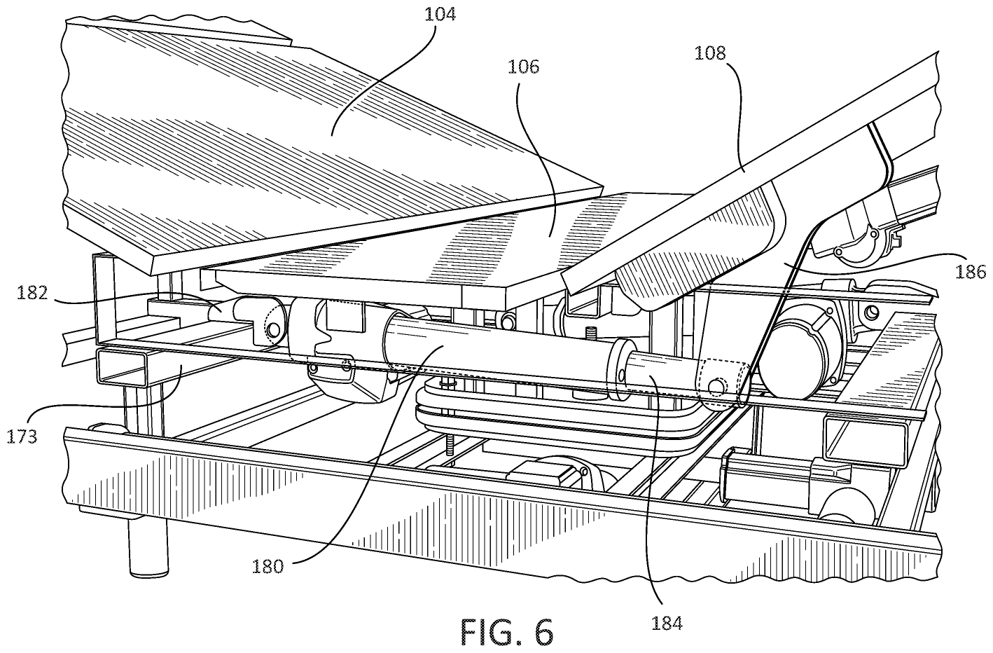

With reference now being made to FIG. 6, the mounting of the thigh section or deck 108 upon the opposite side or end of the seat section or deck 106 to which the back section or deck 104 is mounted, and the movement of the thigh section or deck 108 with respect to the seat section or deck 106, will now be described. More particularly, it is seen that the thigh section or deck 108 is pivotally attached to the opposite side or end of the seat section or deck 106 by means of a plurality of mounting brackets, not shown but similar to the mounting brackets 150,152,154, wherein each one of the mounting brackets comprises two bracket sections connected together by means of a suitable hinge structure such as, for example, a piano hinge mechanism. In addition, a thigh deck actuator 180 is fixedly connected to another transversely oriented beam member 173 of the bed frame 114 by means of a motor mount 182, and the thigh deck actuator 180 comprises an extendable telescopic tube 184. In turn, the extendable telescopic tube 184 is pivotally connected to one end of a clevis connector 186 while the other end of the clevis connector 186 is fixedly connected to a laterally central undersurface portion of the thigh section or deck 108. In this manner, as the telescopic tube 184 is extended out from the thigh deck actuator 180, the thigh section or deck 108 will be pivotally moved with respect to the seat section or deck 106 as may be desired for the proper support and comfort of the thigh portions of the person being moved from the supine position to the seated and partially standing position.

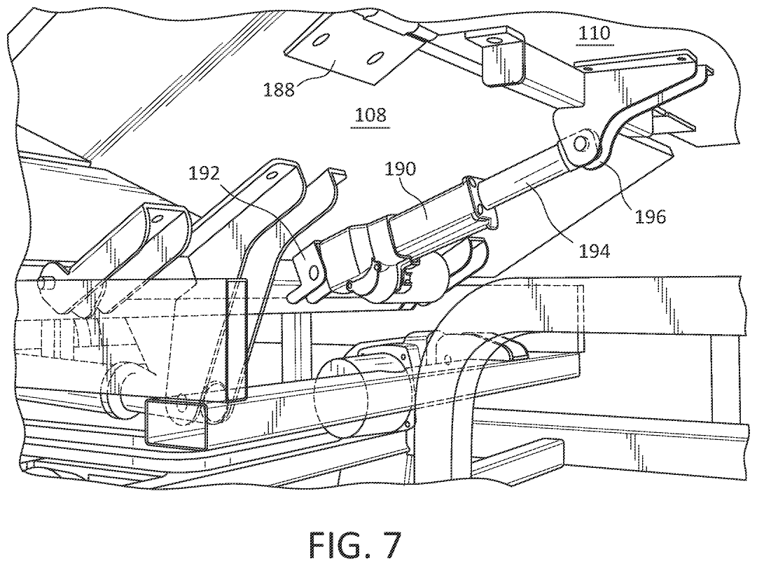

Continuing now with reference being made to FIG. 7, the mounting of the leg section or deck 110 upon the side or end of the thigh section or deck 108 which has its opposite end or side connected to the seat section or deck 106, and the movement of the leg section or deck 110 with respect to the thigh section or deck 108, will now be described. More particularly, it is seen that the leg section or deck 110 is pivotally attached to the opposite side or end of the thigh section or deck 108 by means of a plurality of mounting brackets, only one of which is shown at 188, wherein each one of the mounting brackets 188 comprises two bracket sections connected together by means of a suitable hinge structure such as, for example, a piano hinge mechanism. In addition, a leg deck actuator 190 is fixedly connected to an undersurface portion of the thigh section or deck 108 by means of a suitable motor mount 192, and it is also seen that the leg deck actuator 190 comprises an extendable telescopic tube 194. In turn, the extendable telescopic tube 194 is pivotally connected to one end of a clevis connector 196 while the other end of the clevis connector 196 is fixedly connected to a laterally central undersurface portion of the leg section or deck 110. In this manner, as the telescopic tube 194 is extended out from the leg deck actuator 190, the leg section or deck 110 will be pivotally moved with respect to the thigh section or deck 108 as may be desired for the proper support and comfort of the leg portions of the person being moved from the supine position to the seated and partially standing position.

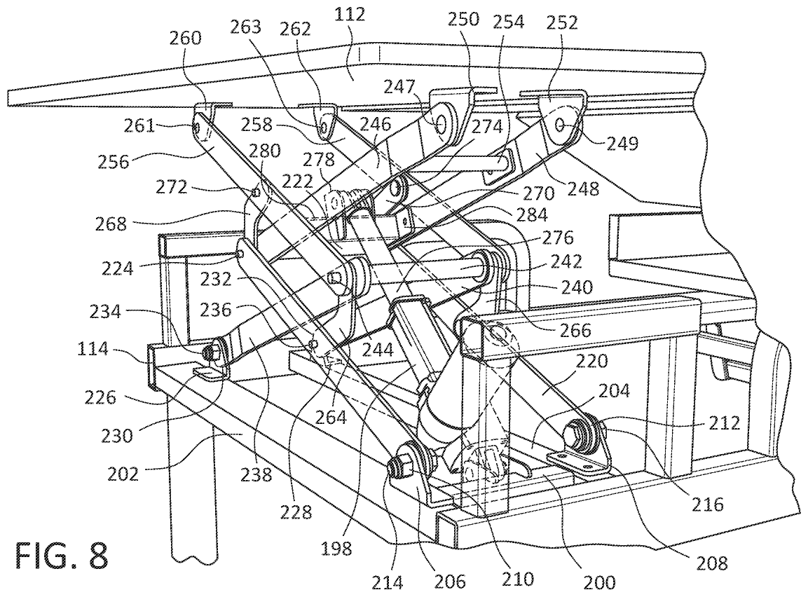

Continuing still further, and with reference being made to FIG. 8, the mounting of the foot section or deck 112 upon the bed frame 114, and the movement of the foot section or deck 112 with respect to the bed frame 114, will now be described. More particularly, as has been previously noted, and as can be particularly appreciated from FIGS. 1-3, while the foot deck or section 112 is operatively controlled in conjunction with the other sections or decks 102-110 through means of a suitable central processing unit (CPU) or a programmable logic computer (PLC), as will be more fully disclosed and discussed hereinafter, the foot section or deck 112 is structurally separate and apart from all of the other sections or decks 102-110 and, in lieu of moving pivotally, the foot section or deck 112 effectively moves linearly in upward and downward directions. As can be appreciated from FIG. 8, a foot deck actuator 198 has one end thereof pivotally mounted upon a transversely oriented mounting plate 200, and opposite ends of the transverse oriented mounting plate 200 are fixedly secured to longitudinally extending frame members 202,204 of the bed frame 114.

A pair of L-shaped mounting brackets 206,208 are also respectively mounted upon the longitudinally extending frame members 202,204, and each one of the vertically oriented, upstanding portions of the L-shaped mounting brackets 206,208 has a bushing 210,212 mounted thereon, through which a pair of axle rods 214,216 respectively pass so as to effectively serve as pivot axes around which first or lower end portions of a first pair of foot section or deck actuating links 218,220 are pivotally secured. The second or opposite end portions of the first pair of foot section or deck actuating links 218,220 are connected together by means of a first transversely oriented axle rod 222, the opposite ends of which 224, only one of which is visible, serve as pivot axles which pass through the second opposite end portions of the first pair of foot section or deck actuating links 218,220. In a similar manner, a pair of L-shaped mounting brackets 226,228 are respectively mounted upon the longitudinally extending frame members 202,204 adjacent to the corner regions of the bed frame 114, and each one of the vertically oriented, upstanding portions of the L-shaped mounting brackets 226,228 has a bushing 230,232 mounted thereon, through which a pair of axle rods 234,236 respectively pass so as to effectively serve as pivot axes around which first, lower end portions of a second pair of foot section or deck actuating links 238,240 are pivotally secured. The second, opposite end portions of the second pair of foot section or deck actuating links 238,240 are connected together by means of a second transversely oriented axle rod 242, the opposite ends of which 244, only one of which is visible, serve as pivot axles which pass through the second, opposite end portions of the second pair of foot section or deck actuating links 238,240.

With reference still being made to FIG. 8, a third pair of foot section or deck actuating links 246,248 have first lower end portions thereof respectively connected in a pivotal manner to the second upper end portions of the first pair of foot section or deck actuating links 218,220 through means of the pivot axles 224, while second, opposite upper end portions of the third pair of foot section or deck actuating links 246,248 are respectively pivotally connected to a pair of dependent mounting brackets 250,252, as at 247,249, which are affixed to transversely separated undersurface portions of the foot section or deck 112 located adjacent two corner regions of the foot section or deck 112. In addition, it is also seen that a transversely oriented brace bar 254 is fixedly connected to oppositely disposed interior surface portions of the third pair of foot section or deck actuating links 246,248, at locations substantially midway between the opposite end portions of the third pair of foot section or deck actuating links 246,248, so as to maintain the third pair of foot section or deck actuating links 246,248 in parallel alignment with respect to each other throughout the operational phases of raising and lowering the foot section or deck 112, as will be more fully described hereinafter. Still yet further, and in a similar manner, it is also seen that a fourth pair of foot section or deck actuating links 256,258 have first lower end portions thereof respectively connected in a pivotal manner to the second upper end portions of the second pair of foot section or deck actuating links 238,240 through means of the pivot axles 244, while second, opposite upper end portions of the fourth pair of foot section or deck actuating links 256,258 are respectively pivotally connected to dependent mounting brackets 260,262, as at 261,263 which are also affixed to transversely separated undersurface portions of the foot section or deck 112 located within the regions of the other two corners of the foot section or deck 112.

In addition, it is also seen that a first pair of substantially L-shaped or arcuately shaped, oppositely disposed connecting links 264,266 are utilized to interconnect mid-portions of the first pair of foot section or deck actuating links 218,220 to opposite ends of the axle rod 242, while a second pair of substantially L-shaped or arcuately shaped, oppositely disposed connecting links 268,270 are utilized to interconnect mid-portions 272,274 of the fourth pair of foot section or deck actuating links 256,258 to the opposite ends of the axle rod 222. It is lastly seen that the foot section or deck actuator 198 is provided with an extendable telescopic tube 276, and that the distal end of the telescopic tube 276 is pivotally connected to a clevis connector 278 which is fixedly mounted upon a transversely oriented mounting bracket 280 which has a pair of oppositely disposed mounting lugs 282,284, only 284 being visible, which are adapted to be fixedly mounted upon the first, oppositely disposed lower end portions of the third pair of foot section or deck actuating links 246,248 at locations which are adjacent to the transversely oriented axle rod 222. Accordingly, when it is desired to elevate the foot section or deck 112 from its collapsed or lowered position as illustrated within FIG. 2 to the elevated position as illustrated within FIG. 8, the foot section or deck actuator 198 will be activated such that the telescopic tube 276 will be extended so as to force the transversely oriented mounting bracket 280 to be moved upwardly which will, in turn, cause all of the first, second, third, and fourth sets of foot section or deck links 218,220,238,240,246,248,256, and 258 to be elevated or raised, through means of their various pivotal and linkage connections, so as to in fact elevate or raise the foot section or deck 112 to its elevated or raised position. Conversely, when it is desired to move the foot section or deck 112 from its elevated or raised position, as illustrated within FIG. 8, to its collapsed or lowered position as illustrated within FIG. 2, the foot section or deck actuator 198 is activated so as to retract the telescopic tube 276. It is to be lastly noted that the foot section or deck actuator 198 can be activated in a stepwise or continuous controlled manner such that the foot section or deck 112 can be raised or lowered to a multiplicity of different positions.

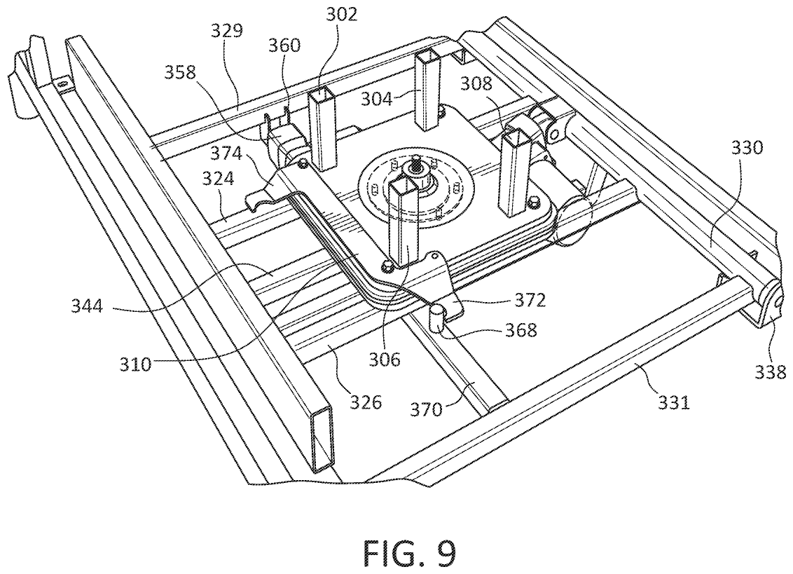

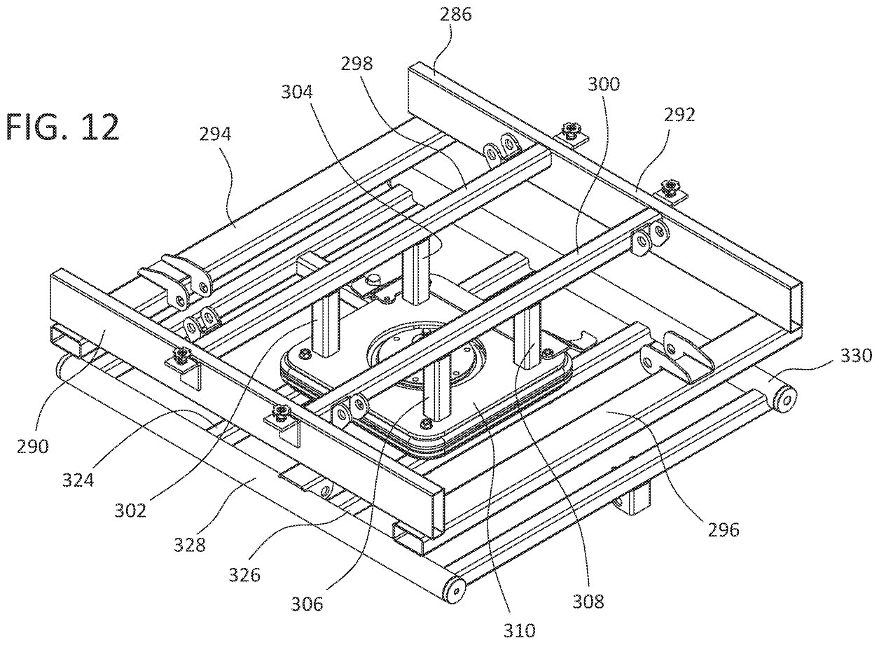

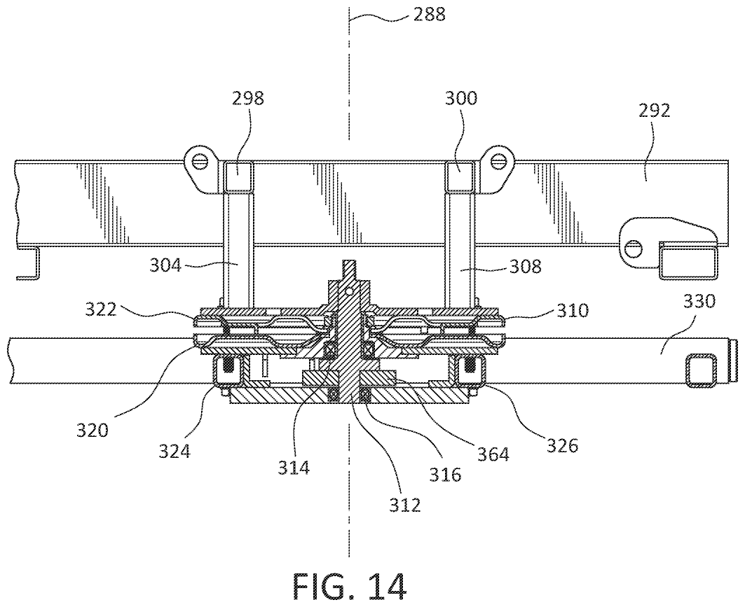

With reference now being made to FIGS. 9-14, the rotational or pivotal and tilting mechanisms of the new and improved bed platform assembly 100 will now be discussed. More particularly, the rotational/pivotal mechanism comprises a substantially square box frame assembly which, as can best be appreciated from FIG. 12, comprises a rotational/pivotal framework 286 which is adapted to rotate or pivot around a vertical axis 288 as can best be appreciated from FIG. 14. The rotational/pivotal framework 286 is seen to comprise a first pair of longitudinally extending, oppositely disposed upstanding beam members 290,292, and a second pair of transversely extending, oppositely disposed cross beams 294,296 upon which undersurface portions of the ends of the first pair of longitudinally extending, oppositely disposed upstanding beam members 290,292 are fixedly secured. In addition, a third pair of transversely extending cross-beams 298,300, which are disposed parallel to each other, are fixedly secured to intermediate portions of first pair of longitudinally extending, oppositely disposed upstanding beam members 290,292 so that all of beam members 290-300 cooperate together so as to define a solid, stable rotational or pivotal framework 286 upon which the seat section or deck 106 is to be fixedly secured. It is further seen that four vertically oriented posts 302,304,306,308 are fixedly connected at their upper ends to undersurface portions of the third pair of transversely extending cross-beams 298,300, while the lower ends of the four vertically oriented posts 302,304,306,308 are fixedly connected to four corner regions of an upper rotational/pivotal platform 310. As can best be appreciated from FIG. 14, it is further seen that the upper rotational/pivotal platform 310 is fixedly mounted upon a vertically oriented axle or spindle 312 which is rotatably mounted within a pair of upper and lower annular ball bearing race assemblies 314,316, wherein the ball bearing race assemblies 314,316 comprise component parts of a tilting chassis 318 of the tilting mechanism.

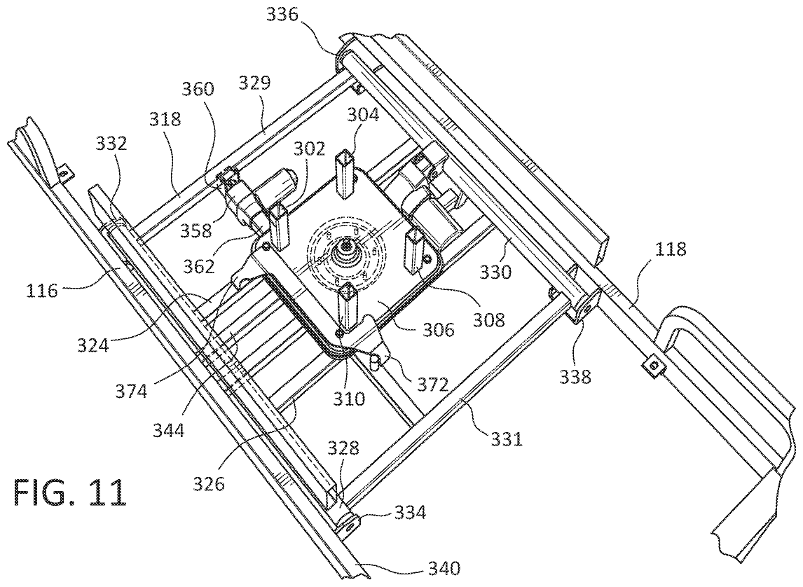

More particularly, it is further seen that the tilting chassis 318 comprises a fixed platform 320 upon which the rotational/pivotal platform 310 is rotatably/pivotally mounted by means of a surface bearing 322 which is interposed between the rotational/pivotal platform 310 and the fixed platform 320. In turn, the fixed platform 320 is fixedly mounted atop a pair of transversely oriented cross-beams 324,326 which have their opposite ends fixedly connected to a pair of longitudinally extending beam members 328,330 of the tilting chassis 318 as can best be appreciated from FIG. 11, while the opposite ends of the longitudinally extending beam members 328,330 are connected to a pair of oppositely disposed end cross-beams 329,331 which respectively interconnect mounting brackets 332,336 and 334,338. It is to be noted further that the longitudinally extending beam member 328 of the tilting chassis 318 is pivotally mounted within a first pair of longitudinally spaced mounting brackets 332,334, however, the longitudinally extending beam member 330 of the tilting chassis 318 is simply accommodated within a second pair of longitudinally spaced mounting brackets 336,338 so as to be removable therefrom when the end of the tilting chassis 318, comprising the longitudinally extending beam member 330, is elevated whereby the tilting chassis 318 will effectively pivot around a pivot axis 340 defined by means of longitudinally extending beam member 328 having its end portions pivotally mounted within the first pair of longitudinally spaced mounting brackets 332,334.

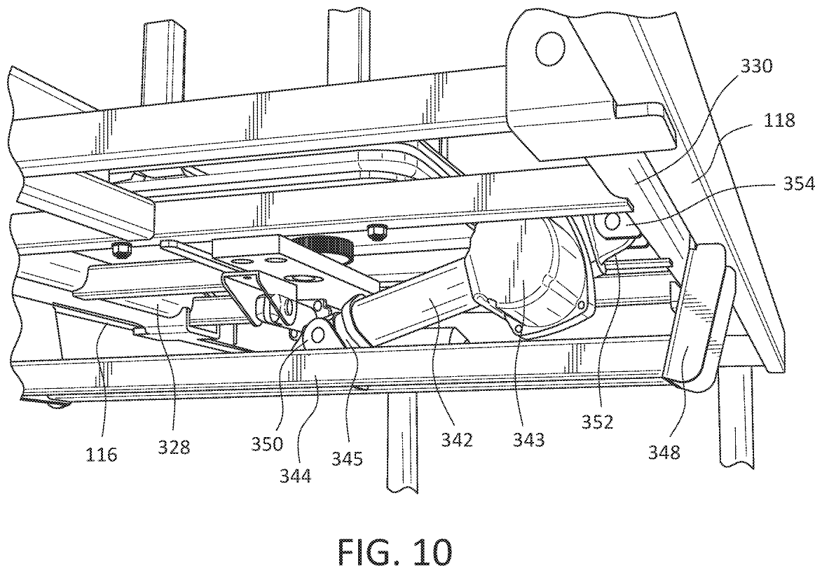

In order to achieve such tilting movement of the tilting chassis 318 around its pivot axis 340, a lifting or tilting linear actuator 342 is provided. As can best be seen from FIGS. 5 and 10, an undercarriage 344 is fixedly secured to the two longitudinally extending, oppositely disposed side frame members 116,118 of the underlying bed frame 114 by means of a pair of oppositely disposed mounting brackets 346,348. More particularly, the lifting or tilting linear actuator 342, which comprises a motor 343 and an extensible telescopic tube 345, is pivotally connected to the undercarriage 344 by means of a suitable telescopic tube mount 350, while the opposite motor end of the lifting or tilting linear actuator 342 is pivotally connected to the longitudinally extending beam member 330 of the tilting chassis 318 by means of a suitable motor bracket 352 and a motor mount 354. Accordingly, when the lifting or tilting linear actuator 342 is activated, the extendable telescopic tube 345 will be extended so as to effectively cause the longitudinally extending beam member 330 of the tilting chassis 318 to be disengaged from the mounting brackets 336,338 and be elevated whereby the tilting chassis 318, along with the rotational/pivotal platform 310 disposed atop the tilting chassis 318, as well as the seat section or deck 106 of the bed platform assembly 100 disposed atop the rotational/pivotal platform 310, to be tilted to a predetermined degree, such as, for example, an angular amount of 23°.

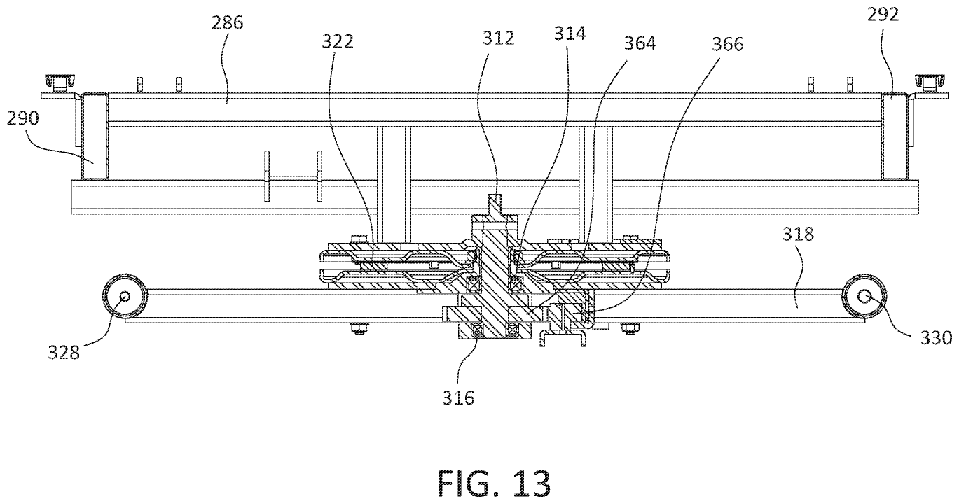

With reference now being made to FIGS. 9,11,13, and 14, a detailed description of the system for rotating/pivoting the rotational/pivotal platform 310 will now be described. As can best be seen from FIGS. 9,11, a rotational/pivotal linear actuator is disclosed at 358 wherein the rotational/pivotal linear actuator 358 is pivotally secured at its proximal end by means of a suitable motor mount 360 which is fixedly secured to the cross-beam 329 of the tilting chassis 318. In turn, the rotational/pivotal linear actuator 358 is provided with an axially extendable telescopic tube 362, which can best be seen in FIG. 11, wherein a distal end portion of the telescopic tube 362 may be supported within a dependent mounting bracket, not shown but fixedly mounted upon the underside of the undercarriage 344 such that the distal end portion of the telescopic tube 362 is freely movable within such dependent mounting bracket. In addition, as can best be seen from FIGS. 13 and 14, an annular rotary gear 364 is fixedly mounted upon the vertically oriented axle or spindle 312 and is adapted to be engaged by means of a rack 366 which is fixedly attached to the freely movable distal end portion of the telescopic tube 362.

In this manner, as the rotational or pivotal linear actuator 358 is activated such that the distal end portion of the telescopic tube 362 will be extended or retracted, the rack 366 will cause the rotary gear 364, the vertically oriented axle or spindle 312, the pivotal or rotational platform 310, the rotational/pivotal framework 286, and the seat section or deck 106 to rotate or pivot within a 90° range of motion so as to effectively rotate the seat section or deck 106 of the bed platform assembly 100 between a first position wherein all of the different sections or decks of the bed frame assembly 100, except for the foot section or deck 112, that is, the neck section or deck 102, the back section or deck 104, the seat section or deck 106, the thigh section or deck 108, and the leg section or deck 110, will be longitudinally aligned with the longitudinal axis LA of the underlying bed frame 114, or a second position wherein all of the different sections or decks of the bed frame assembly 100, except for the foot section or deck 112, that is, the neck section or deck 102, the back section or deck 104, the seat section or deck 106, the thigh section or deck 108, and the leg section or deck 110, will effectively be oriented perpendicular to the longitudinal axis of the underlying bed frame 114.

Still yet further, as can best be seen in FIGS. 9 and 11, a vertically oriented or upstanding limit pin or limit stop 368 is fixedly mounted upon a longitudinally extending beam member 370 which is fixedly connected to the transverse beam 331 at one end thereof, while the second oppositely disposed end of the beam member 370 is connected to the transversely oriented beam member 326. In addition, it is seen that the upper rotational/pivotal platform 310 is provided with a pair of limit engagement claws 372,374 which are fixedly secured to side surface portions of the upper rotational/pivotal platform 310 which are disposed at 90° with respect to each other. In this manner, it can be appreciated that as the upper rotational/pivotal platform 310 is rotated in the clockwise direction, as viewed in FIG. 9, the limit engagement claw 372 will engage the upstanding limit pin or limit stop 368 so as to thereby arrest further rotational or pivotal movement of the upper rotational or pivotal platform 310 in the clockwise direction, while conversely, as the upper rotational/pivotal platform 310 is rotated in the counterclockwise direction, as viewed in FIG. 9, the limit engagement claw 374 will engage the upstanding limit pin or limit stop 368 so as to thereby arrest further rotational or pivotal movement of the upper rotational or pivotal platform 310 in the counterclockwise direction. Accordingly, the engaged interactions between the upstanding limit pin or limit stop 368 and the limit engagement claws 372,374 precisely define the aforenoted relative perpendicular rotational positions of the seat section or deck 106, and the other sections or decks connected thereto, relative to the underlying bed frame 114.

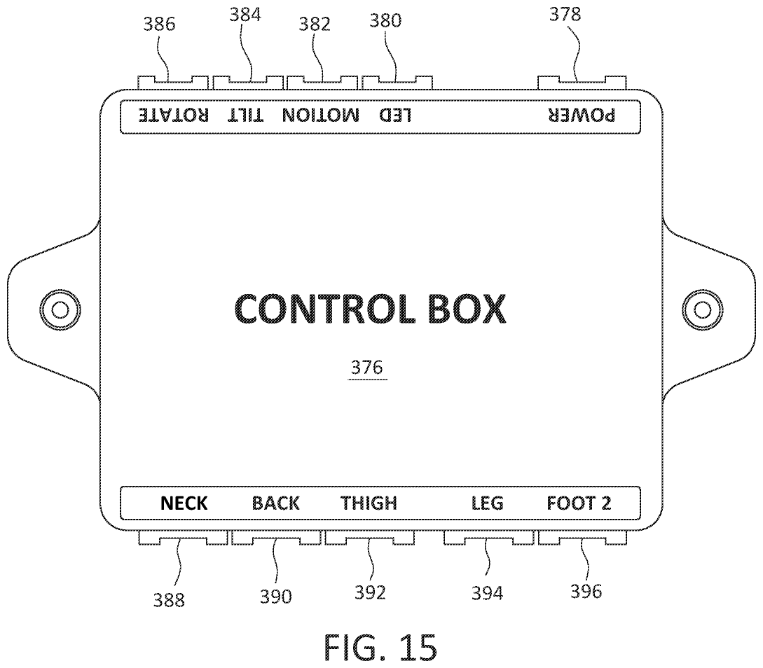

With reference lastly being made to FIG. 15, a control box 376 is schematically illustrated, wherein the control box 376 is part of a central processing unit (CPU) or a programmable logic computer (PLC) and which has a plurality of control buttons 378-396 mounted thereon for automatically actuating the various linear actuators which have been discussed hereinbefore. For example, control button 376 controls power to the various components of the new and improved bed platform assembly 100, while a control button 380 controls power to LED lighting which is disposed beneath the underlying bed frame 114 so as to illuminate the area surrounding the bed platform assembly 100 as necessary. Still further, control button 382 controls power to a motion sensor which detects movement of the person lying upon the new and improved bed platform assembly 100 and in response to the detection of such movement of the person lying upon the new and improved bed platform assembly 100, the motion sensor 382 will activate the LED lighting. Continuing further, control button 384 controls power to the lifting or tilting actuator 342, control button 386 controls power to the rotational or pivotal actuator 358, control button 388 controls power to the neck section or deck drive linear actuator 162, control button 390 controls power to the back section or deck drive linear actuator 170, control button 392 controls power to the thigh section or deck drive linear actuator 180, control button 394 controls power to the leg section or deck drive linear actuator 190, and control button 396 controls power to the foot section or deck drive linear actuator 198.

Having described all of the operative components of the new and improved bed platform assembly 100 of the present invention, a brief description of the operation of the same will now be described. When a person is disposed atop the new and improved bed platform assembly 100 of the present invention, all of the operative components will be disposed at positions which are effectively illustrated within FIG. 2 such that the operative components are disposed within the horizontal plane HP whereby the person can be appropriately supported in a supine position atop the new and improved bed platform assembly 100. When it is desired to move the person, lying upon the bed platform assembly 100 from the supine position to a seated and standing position, the linear actuator 170 for the back deck or section 104 is activated first so as to slowly move the back deck or section 104, from its normally flat, horizontally oriented position, to an upward or elevated inclined position of approximately 45° degrees such that the person's back is properly supported in the inclined position. It is noted that the linear actuator 162 for the neck deck or section 102 can also be activated at this time, if desired, so as to likewise position and support the person's neck at a suitably comfortable angle with respect to the back deck or section 104.

The thigh, leg, and foot linear actuators 180,190,198 are then activated so as to respectively elevate the thigh, leg, and foot sections or decks 108,110, 112 to predetermined elevated positions, as well as to support the thighs, legs, and feet of the person at such elevated positions in preparation for the person to ultimately be moved to the ultimately desirable seated and standing positions. The linear actuator 198 for the foot deck or section 112 is then operated in reverse so as to lower the foot deck or section such that the foot deck or section is now at an elevation which is substantially below that at which the person's thighs and legs are disposed. Alternatively, the foot section or deck 112 need not be actuated at all but will nevertheless form an integral part of the upper section or deck portion of the bed platform assembly 100 so as to properly support the person lying in the supine position within the horizontal plane HP. Alternatively, still further, the foot section or deck 112 may not have a linear actuator 198 and all of the interconnected actuating links 218,220,238,240, 246,248, and 256,258 so as to simply serve as a foot support providing the proper support for the person's feet when the person is disposed in the supine position within the horizontal plate HP. In either of the aforenoted alternative embodiments, whenever the back section or deck 104, the thigh section or deck 108, and the leg section or deck 110 are elevated by means of their respective linear actuators 170,180, and 190 are activated, the person's thighs and legs will be disposed at an elevational level which is above that of the foot section or deck 112.

Subsequently, the linear actuator 358 for the rotational or pivotal framework 286 is activated such that the seat deck or section 106, fixedly mounted upon the rotational/pivotal framework 286, is rotated 90° along with the neck and back sections or decks 102,104, the thigh section or deck 108, and the leg section or deck 110, since all of such sections or decks are connected together in an articulated manner as has been previously disclosed. In this manner, it can be appreciated that the person is now effectively positioned perpendicular to the longitudinal extent or axis LA of the underlying bed frame 114 and that the person's legs now extend over a side edge portion of the underlying bed frame 114 and are disposed at a predetermined height or elevation above the floor 124 upon which the underlying bed frame 114 is disposed. It can be appreciated further that since the foot section or deck 112 was lowered back to its normal or retracted position, or, alternatively, was never vertically moved at all, the foot section or deck 112 will not interfere with, or encounter, the person's legs when the rotational/pivot framework 286, along with the seat section or deck 106, is rotated through the aforenoted 90° rotational or pivotal movement.

It is to be appreciated that once the person has attained the aforenoted 90° rotational or pivotal position with respect to the underlying bed frame 114 such that the person's legs now extend over a side edge portion of the underlying bed frame 114 and are disposed at a predetermined height or elevation above the floor 124 upon which the underlying bed frame 114 is disposed, the linear actuator 342 for the tilting chassis 318 will be activated to a predetermined degree, such as, for example, 23° with respect to its normal horizontal position, so as to effectively move the person to an inclined seated position. Subsequently, the linear actuators 180,190 for the person's thighs and legs are retracted such that the person's thighs and legs are moved downwardly whereby the person's feet are now able to touch the floor 124, at which time the person may be assisted by hospital or other facility personnel or staff so as to attain a fully standing position, or alternatively, the person himself may be able to attain a fully standing or erect position by using, for example, a walker or other device for enabling the person to ambulate as desired. It is to be lastly appreciated that the mode of operation of the bed platform assembly 100 can effectively be conducted in reverse whereby a person, having navigated toward the side of the underlying bed frame 114, either alone or with assistance from hospital or other facility staff or personnel, can be seated, and subsequently, the various linear actuators 342,358,198,190,180,170, and 162 can be activated in reverse modes of operation so as to effectively return the person to the supine position after the person has completed his or her ambulatory or physical therapy movements or exercises.

Obviously, many variations and modifications of the present invention are possible in light of the above teachings. It is therefore to be understood that within the scope of the appended claims, the present invention may be practiced otherwise than as specifically described-herein.

What is claimed and desired to be protected by Letters Patent is:

1. A bed platform assembly for automatically moving a person from a supine position to a seated position such that the person can be assisted to a standing position, comprising:
an underlying bed frame having a longitudinal axis;
a back section, for supporting a person's back, disposed above said underlying bed frame;
a seat section, for supporting a lower portion of a person's torso, disposed above said underlying bed frame and connected to said back section;
a leg section, for supporting legs of a person, disposed above said underlying bed frame and connected to said seat section; and
a plurality of actuators for elevating said back section of said bed platform assembly to an inclined position, rotating said seat section 90° with respect to said longitudinal axis of said underlying bed frame, and for lowering said leg section of said bed platform assembly,
whereby the person, originally disposed in said supine position, is now disposed in a seated position with its leg members disposed over a side portion of said underlying bed frame so that another person may help the person from said seated position to a standing position.

2. The bed platform assembly as set forth in claim 1, further comprising:
a neck section connected to said back section; and
a neck section actuator operatively connected to said neck section for moving said neck section relative to said back section.

3. The bed platform assembly as set forth in claim 1, further comprising:
a thigh section interposed between said back section and said leg section and operatively connected at opposite ends of said thigh section to said back section and said leg section; and
a thigh section actuator operatively connected to said thigh section for moving said thigh section relative to said back and leg sections.

4. The bed platform assembly as set forth in claim 1, further comprising:
a rotational/pivotal platform upon which said seat section is fixedly secured so as to enable said seat section, and said back and leg sections connected to said seat section, to undergo predeterminedly opposite clockwise and counterclockwise rotational/pivotal movements of 90° within a horizontal plane such that said seat section, said back section, and said leg section are alternatively aligned with said longitudinal axis of said underlying bed frame and disposed within a plane perpendicular to said longitudinal axis of said underlying bed frame.

5. The bed platform assembly as set forth in claim 1, further comprising:
a tilting chassis pivotally mounted upon one side of said underlying bed frame and upon which said seat section is rotationally/pivotally disposed; and
a tilting chassis actuator operatively connected to an opposite side of said tilting chassis for tilting said tilting chassis, and said seat section mounted thereon, to a predetermined tilted degree with respect to said underlying bed frame,
whereby, once the person, originally disposed in said supine position, has been moved to said seated position with its leg members disposed over a side portion of said underlying bed frame, said tilting actuator can tilt said tilting chassis and said seat section such that the person, seated upon said seat section, can now be moved upwardly to a semi-standing/semi-erect position so that another person may help the person from said semi-standing/semi-erect position to a fully standing position.

6. The bed platform assembly as set forth in claim 5, wherein:
said tilting chassis actuator can tilt said tilting chassis to a predetermined degree of 23°.

7. The bed platform assembly as set forth in claim 1, further comprising:
a rotational/pivotal platform upon which said seat section is fixedly secured so as to enable said seat section, and said back and leg sections connected to said seat section, to undergo predeterminedly opposite clockwise and counterclockwise rotational/pivotal movements of 90° within a horizontal plane;
a tilting chassis pivotally mounted upon one side of said underlying bed frame and upon which said seat section is rotationally/pivotally disposed; and
a surface bearing interposed between said rotational/pivotal platform and said tilting chassis so as to permit said rotational/pivotal platform, upon which said seat section is fixedly secured, to undergo said predeterminedly opposite clockwise and counterclockwise rotational/pivotal movements of 90° within a horizontal plane relative to said tilting chassis.

8. The bed platform assembly as set forth in claim 7, further comprising:
a vertically oriented limit pin mounted upon said tilting chassis; and
a pair of limit engagement claws mounted upon said rotational or pivotal platform for engaging said vertically oriented limit pin so as to prevent further rotational/pivotal movement of said rotational/pivotal platform in either one of said clockwise and counterclockwise directions.

9. The bed platform assembly as set forth in claim 7, further comprising:
a vertically oriented axle/spindle mounted upon said tilting chassis and upon which said rotational/pivotal platform is mounted so as to permit said rotational/pivotal platform to rotate around a vertical axis defined by said vertically oriented axle/spindle.

10. The bed platform assembly as set forth in claim 9, further comprising:
an annular gear fixedly mounted upon said vertically oriented axle/spindle;
a rotational/pivotal platform actuator mounted upon said tilting chassis; and
a rack connected to a distal end portion of said rotational/pivotal platform actuator and adapted to engage said annular gear fixedly mounted upon said vertically oriented axle/spindle such that when said rotational/pivotal platform actuator is extended and retracted, said rack will cause said annular rotary gear to rotate in opposite directions so as to enable said rotational/pivotal platform to achieve said opposite clockwise and counterclockwise rotational/pivotal movements of 90° relative to said tilting chassis and said underlying bed frame.

11. The bed platform assembly as set forth in claim 1, further comprising:
a foot section for supporting the person's feet.

12. The bed platform assembly as set forth in claim 1, further comprising:
a foot section actuator for moving said foot section from a lowered, collapsed position to an elevated position, and back to said lowered, collapsed position, so as to properly support the feet of the person as desired; and
a plurality of interconnected actuating links connecting said foot section actuator to said foot section so as to elevate and lower said foot section when said foot section actuator is respectively extended and retracted.

13. The bed platform assembly as set forth in claim 1, further comprising:
a control box for controlling all moving component parts of said bed platform assembly.

14. The bed platform assembly as set forth in claim 13, wherein:
said control box comprises a central processing unit (CPU) or a programmable logic computer (PLC).

15. The bed platform assembly as set forth in claim 1, further comprising:
a motion sensor for sensing motion or movement of the person disposed in said supine position upon said bed platform assembly.

16. The bed platform assembly as set forth in claim 15, further comprising:
LED perimeter lights disposed upon said underlying bed frame and illuminated when said motion sensor detects motion or movement of the person disposed in said supine position upon said bed platform assembly.
